(19) United States
(12) Patent Application Publication
(10) Pub. No.: US 2024/0257449 A1
(43) Pub. Date: Aug. 1, 2024

(54) GENERATING HARD OBJECT SHADOWS FOR GENERAL SHADOW RECEIVERS WITHIN DIGITAL IMAGES UTILIZING HEIGHT MAPS

(71) Applicant: Adobe Inc., San Jose, CA (US)

(72) Inventors: Jianming Zhang, Campbell, CA (US); Yichen Sheng, West Lafayette, IN (US)

(21) Appl. No.: 18/162,317

(22) Filed: Jan. 31, 2023

(51) Int. Cl. G06T 15/60; G06T 7/60; G06T 7/73

(52) U.S. Cl. CPC G06T 15/60; G06T 7/60; G06T 7/73; G06T 2207/20084; G06T 2215/12

(57) ABSTRACT

The present disclosure relates to systems, methods, and non-transitory computer-readable media that generates object shadows for digital images utilizing height maps for the digital objects and background portrayed therein. For instance, in one or more embodiments, the disclosed systems generate, utilizing a height prediction neural network, an object height map comprising pixel heights for pixels of a digital object portrayed in a digital image. The disclosed system also generate, utilizing the height prediction neural network, a background height map comprising additional pixel heights for pixels of a background portrayed in the digital image. Further, the disclosed systems modify the digital image to include an object shadow for the digital object using the object height map and the background height map.

### BACKGROUND

Recent years have seen significant advancement in hardware and software platforms for editing digital images. Indeed, as the use of digital images has become increasingly ubiquitous, systems have developed to facilitate the manipulation of the content within such digital images. For example, in the field of digital image editing, computer-implemented tools or models can alter how digital objects appear within digital images, such as by creating shadows cast by digital objects across the backgrounds of the digital images.

### SUMMARY

One or more embodiments described herein provide benefits and/or solve one or more problems in the art with systems, methods, and non-transitory computer-readable media that flexibly generate accurate object shadows for general shadow receivers within digital images utilizing corresponding height maps. To illustrate, in one or more embodiments, a system generates height maps that indicate pixels heights for a background and an object portrayed in a digital image. Using these height maps, the system identifies background pixels that are occluded from the light source of the digital image by object pixels. In particular, in some cases, the system uses the height maps to determine a shadow projection of the object onto one or more surfaces of the background based on the collinear property. Based on the determined shadow projection, the system generates a shadow (e.g., a hard shadow) for the object within the digital image. In this manner, the system implements a flexible shadow rendering algorithm that generates accurate shadow representations across general surfaces of digital images, including non-planar surfaces.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a height-based shadowing system operates in accordance with one or more embodiments;

FIGS. 2A-2B illustrates overview diagrams of the height-based shadowing system modifying a digital image to include a hard object shadow for a digital object portrayed therein in accordance with one or more embodiments;

FIG. 3A illustrates a diagram for using a height prediction neural network to generate an object height map for a digital object portrayed in a digital image in accordance with one or more embodiments;

FIG. 3B illustrates a diagram for using a height prediction neural network to generate a background height map for a background portrayed in a digital image in accordance with one or more embodiments;

FIG. 3C illustrates an architecture of a height prediction neural network that generates height maps for digital images in accordance with one or more embodiments;

FIG. 3D illustrates a diagram for generating a height prediction neural network to generate height maps in accordance with one or more embodiments;

FIGS. 4A-4B illustrate diagrams for determining shadow projections for the pixels of a digital object using an object height map, a background height map, and light source information in accordance with one or more embodiments;

FIG. 5 illustrates a diagram for generating a soft object shadow utilizing a shadow stylization neural network in accordance with one or more embodiments;

FIG. 6 illustrates example hard object shadows and soft object shadows generated by the height-based shadowing system in accordance with one or more embodiments;

FIG. 7 illustrates an example schematic diagram of a height-based shadowing system in accordance with one or more embodiments;

FIG. 8 illustrates a flowchart for a series of acts for generating an object shadow for a digital object using height maps in accordance with one or more embodiments; and

FIG. 9 illustrates a block diagram of an exemplary computing device in accordance with one or more embodiments.

### DETAILED DESCRIPTION

One or more embodiments described herein include a height-based shadowing system that flexibly generalizes shadow rendering within digital images utilizing height maps for the objects and backgrounds portrayed therein. As indicated above, the field of digital image editing implements various systems that utilize computer-implemented tools or models to alter how digital objects appear within digital images, such as by creating shadows for the digital objects within the digital images. These systems, however, suffer from several technological shortcomings that result in inflexible and inaccurate operation.

To illustrate, conventional image shadowing systems are typically inflexible in that they implement shadow rendering algorithms for a limited set of shadow receivers. For example, many conventional systems generate shadows based on an assumption that the shadow receiver of a digital image is a planar surface and that the object for which the shadow is to be generated is positioned on top of the planar surface. Accordingly, such systems fail to flexibly accommodate other scenarios portrayed within digital images, such as those where the shadow receiver includes a non-planer surface (e.g., having a wall or stairs) and/or the object located somewhere other than on top of the portrayed surface.

Additionally, conventional image shadowing systems often fail to operate accurately. In particular, conventional systems often fail to generate shadows that accurately represent a projection of an object across a background of a digital image based in accordance with an associated light source. For instance, by generating shadows based a limited assumption of non-planar surfaces and object positioning, conventional systems typically fail to generate accurate shadows within digital images that do not satisfy that assumption. Indeed, where digital images fail to satisfy the assumption, the generated shadows appear unnatural against their respective backgrounds, causing unrealistic image results. For example, composite images produced using such shadow rendering techniques often fail to realistically portray the object against the composition background.

As suggested, in one or more embodiments, the height-based shadowing system implements a generalized shadow rendering algorithm that operates within the pixel height domain. In particular, in some embodiments, the height-based shadowing system generates height maps that provide pixel height representations for the object and background portrayed in a digital image. Using these pixel height representations, the height-based shadowing system determines whether a given background pixel is occluded by any of the object pixels via back tracing. If the background pixel is occluded, the height-based shadowing systems associates the background pixel with a shadow of the object. Accordingly, the height-based shadowing system generates the shadow for the object within the digital image.

To illustrate, in one or more embodiments, the height-based shadowing system generates, utilizing a height prediction neural network, an object height map comprising pixel heights for pixels of a digital object portrayed in a digital image. The height-based shadowing system further generates, utilizing the height prediction neural network, a background height map comprising additional pixel heights for pixels of a background portrayed in the digital image. Using the object height map and the background height map, the height-based shadowing system modifies the digital image to include an object shadow for the digital object.

As indicated above, in one or more embodiments, the height-based shadowing system generates height maps for a digital image. In particular, the height-based shadowing system generates the height maps utilizing a height prediction neural network. For example, in some cases, the height-based shadowing system utilizes the height prediction neural network to analyze one or more cutouts, one or more masks, and/or a coordinate scheme corresponding to the digital image and generate the height maps based on the analysis.

In some embodiments, the height-based shadowing system generates a background height map for a background portrayed in the digital image. In some cases, the background height map indicates, for the pixels of the background, pixels heights within an image space. Similarly, in some implementations, the height-based shadowing system generates an object height map that indicates additional pixel heights for the pixels of the digital object portrayed in the digital image.

As further mentioned, in one or more embodiments, the height-based shadowing system utilizes the height maps to determine which pixels within the digital image correspond to a shadow cast by the digital object. In particular, in some embodiments, the height-based shadowing system utilizes the height maps to determine whether a given pixel of the background is to be included within an object shadow generated for the digital object.

To illustrate, in one or more embodiments, the height-based shadowing system determines a line or ray from the light source corresponding to the digital image to a pixel of the background. The height-based shadowing system also utilizes the height maps to determine a projection of the line or ray onto a ground surface. The height-based shadowing system further determines whether any pixels of the digital object positioned on the line or ray between the light source and the pixel of the background have a projection that falls on the line/ray projection. Accordingly, the height-based shadowing system identifies which pixels of the background correspond to a shadow cast by the digital object and generates an object shadow for the digital object accordingly.

In some cases, the height-based shadowing system generates a hard object shadow for a digital object portrayed in a digital image utilizing the height maps as described above. In some implementations, the height-based shadowing system further generates a soft object shadow from the hard object shadow. For instance, in some cases, the height-based shadowing system utilizes a shadow stylization neural network to create a soft object shadow by modifying the hard object shadow.

The height-based shadowing system provides advantages over conventional systems. For example, the height-based shadowing system operates with improved flexibility when compared to conventional systems. In particular, the height-based shadowing system flexibly generates object shadows for a broader set of shadow receivers portrayed in digital images. Indeed, by generating a background height map for a digital image, the height-based shadowing system determines the shape of the background portrayed therein and subsequently generates an object shadow based on this shape. Accordingly, the height-based shadowing system generalizes shadow receivers for which shadow rendering is performed to include surfaces that are not accommodated under conventional systems-such as non-planar surfaces. Further, by utilizing background height maps and object height maps to generate object shadows, the height-based shadowing system more flexibly generates object shadows in scenarios where a digital object is not positioned directly on a ground surface.

The height-based shadowing system further operates with improved accuracy when compared to conventional systems. Indeed, by generalizing the shadow receivers for which shadow rendering is performed, the height-based shadowing system generates object shadows that more accurately represent the shadow projections of digital objects across these shadow receivers in many instances. For instance, the height-based shadowing system generates more accurate object shadows across non-planar surfaces when compared to conventional systems.

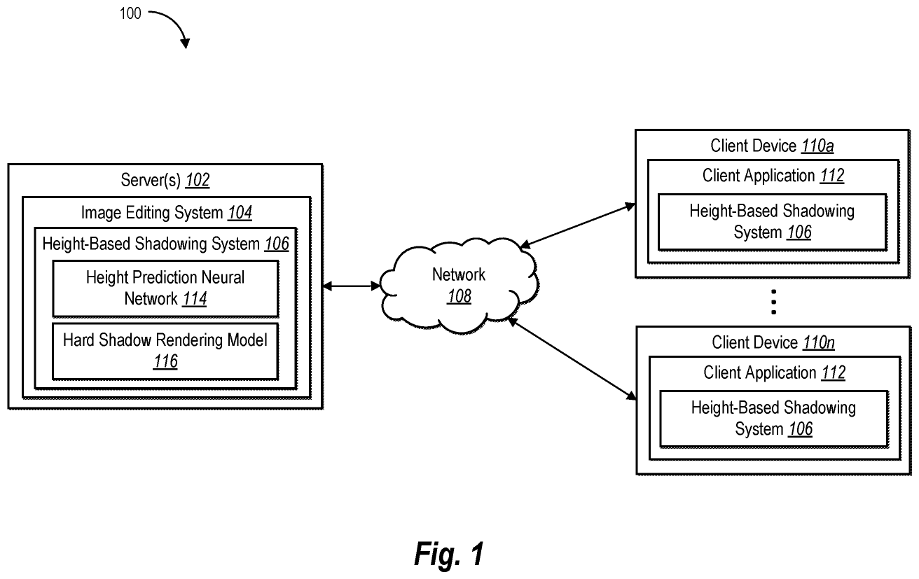

Additional detail regarding the height-based shadowing system will now be provided with reference to the figures. For example, FIG. 1 illustrates a schematic diagram of an exemplary system 100 in which a height-based shadowing system 106 operates. As illustrated in FIG. 1, the system 100 includes a server(s) 102, a network 108, and client devices 110a-110n.

Although the system 100 of FIG. 1 is depicted as having a particular number of components, the system 100 is capable of having any number of additional or alternative components (e.g., any number of servers, client devices, or other components in communication with the height-based shadowing system 106 via the network 108). Similarly, although FIG. 1 illustrates a particular arrangement of the server(s) 102, the network 108, and the client devices 110a-110n, various additional arrangements are possible.

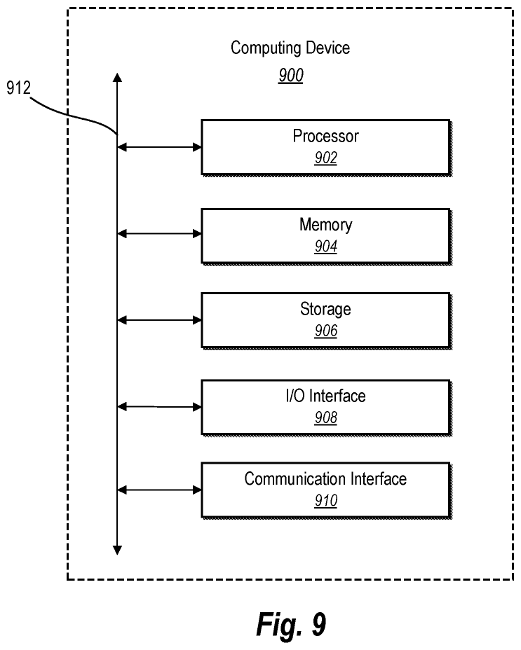

The server(s) 102, the network 108, and the client devices 110a-110n are communicatively coupled with each other either directly or indirectly (e.g., through the network 108 discussed in greater detail below in relation to FIG. 9). Moreover, the server(s) 102 and the client devices 110a-110n include one or more of a variety of computing devices (including one or more computing devices as discussed in greater detail with relation to FIG. 9).

As mentioned above, the system 100 includes the server(s) 102. In one or more embodiments, the server(s) 102 generates, stores, receives, and/or transmits data, including digital images and modified digital images (e.g., digital images modified to include object shadows for digital objects portrayed in the digital images). In one or more embodiments, the server(s) 102 comprises a data server. In some implementations, the server(s) 102 comprises a communication server or a web-hosting server.

In one or more embodiments, the image editing system 104 provides functionality by which a client device (e.g., one of the client devices 110a-110n) generates, edits, manages, and/or stores digital images. For example, in some instances, a client device sends a digital image to the image editing system 104 hosted on the server(s) 102 via the network 108. The image editing system 104 then provides many options that the client device may use to edit the digital image, store the digital image, and subsequently search for, access, and view the digital image.

In one or more embodiments, the client devices 110a-110n include computing devices that display and/or modify digital images. For example, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that display and/or modify digital images. For example, in one or more embodiments, the client application 112 includes a software application installed on the client devices 110a-110n. Additionally, or alternatively, the client application 112 includes a web browser or other application that accesses a software application hosted on the server(s) 102 (and supported by the image editing system 104).

To provide an example implementation, in some embodiments, the height-based shadowing system 106 on the server(s) 102 supports the height-based shadowing system 106 on the client device 110n. For instance, in some cases, the height-based shadowing system 106 on the server(s) 102 generates or learns parameters for the height prediction neural network 114 and the hard shadow rendering model 116. The height-based shadowing system 106 then, via the server(s) 102, provides the height prediction neural network 114 and the hard shadow rendering model 116 to the client device 110n. In other words, the client device 110n obtains (e.g., downloads) the height prediction neural network 114 and the hard shadow rendering model 116 (e.g., with any learned parameters) from the server(s) 102. Once downloaded, the height-based shadowing system 106 on the client device 110n utilizes the height prediction neural network 114 and the hard shadow rendering model 116 to generate object shadows (e.g., hard object shadows) for objects portrayed within digital images independent from the server(s) 102.

In alternative implementations, the height-based shadowing system 106 includes a web hosting application that allows the client device 110n to interact with content and services hosted on the server(s) 102. To illustrate, in one or more implementations, the client device 110n accesses a software application supported by the server(s) 102. In response, the height-based shadowing system 106 on the server(s) 102 modifies a digital image to include an object shadow for a digital object portrayed therein. The server(s) 102 then provides the modified digital image to the client device 110n for display.

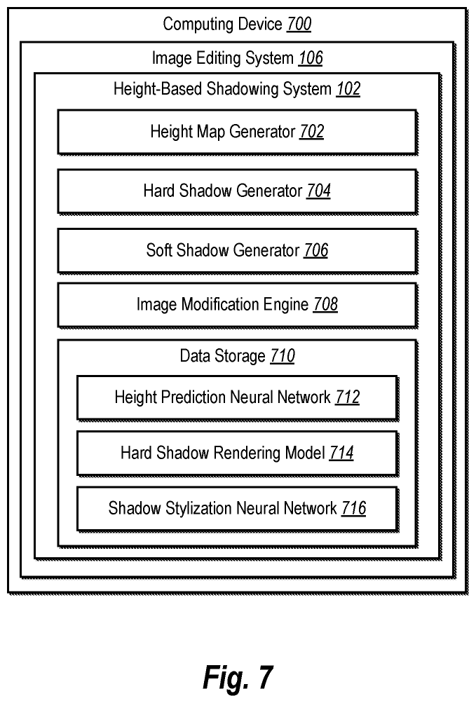

Indeed, the height-based shadowing system 106 is able to be implemented in whole, or in part, by the individual elements of the system 100. Indeed, although FIG. 1 illustrates the height-based shadowing system 106 implemented with regard to the server(s) 102, different components of the height-based shadowing system 106 are able to be implemented by a variety of devices within the system 100. For example, one or more (or all) components of the height-based shadowing system 106 are implemented by a different computing device (e.g., one of the client devices 110a-110n) or a separate server from the server(s) 102 hosting the image editing system 104. Indeed, as shown in FIG. 1, the client devices 110a-110n include the height-based shadowing system 106. Example components of the height-based shadowing system 106 will be described below with regard to FIG. 7.

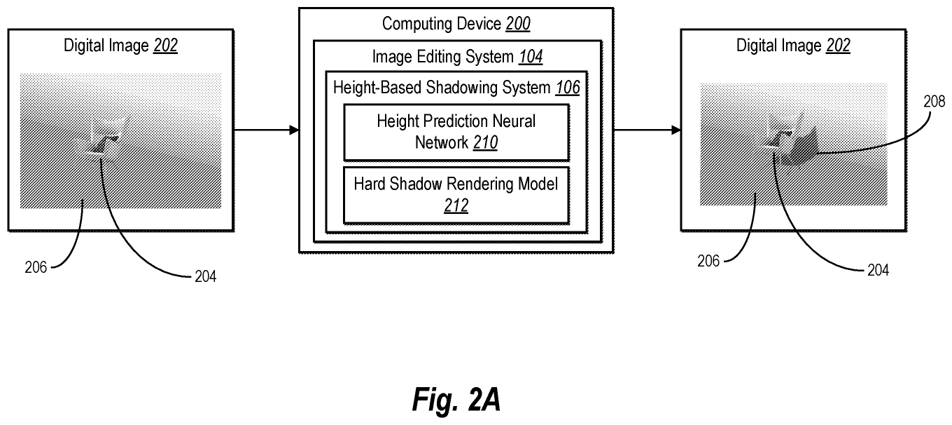

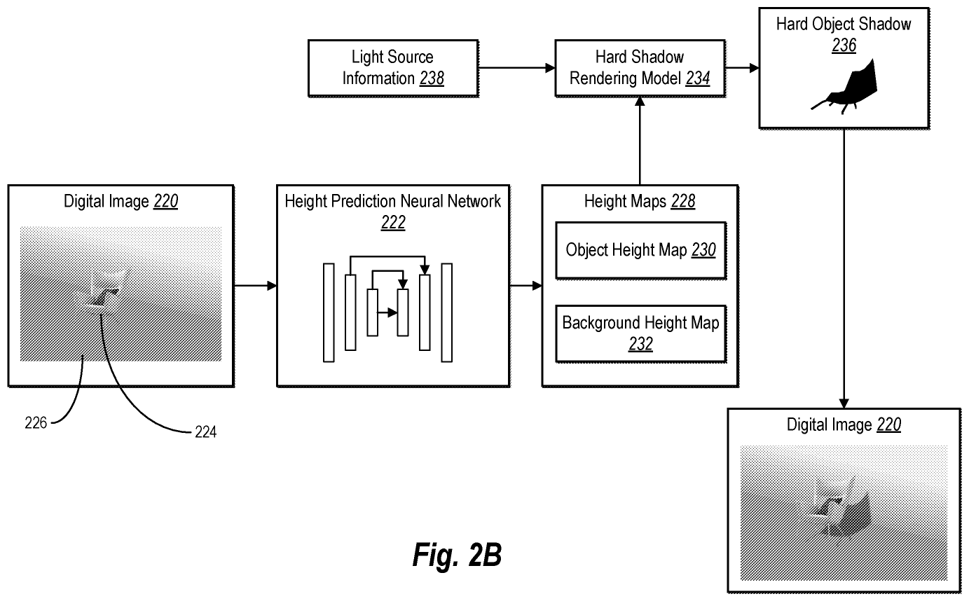

As mentioned above, in one or more embodiments, the height-based shadowing system 106 modifies a digital image to include an object shadow for a digital object portrayed in the digital image. FIGS. 2A-2B illustrate overview diagrams of the height-based shadowing system 106 modifying a digital image to include an object shadow in accordance with one or more embodiments.

As shown in FIG. 2A, the height-based shadowing system 106 (operating on a computing device 200) receives, retrieves, or otherwise obtains a digital image 202. For instance, in one or more embodiments, the height-based shadowing system 106 receives the digital image 202 from a computing device (e.g., a server hosting a third-party system or a client device). In some embodiments, the height-based shadowing system 106 accesses the digital image 202 via a database storing digital images. For example, in at least one implementation, the height-based shadowing system 106 maintains a database and stores a plurality of digital images therein. In some instances, an external device or system stores one or more digital images for access by the height-based shadowing system 106.

As illustrated in FIG. 2A, the digital image 202 portrays a digital object 204 (e.g., a chair). In one or more embodiments, a digital object includes an item or object portrayed in a digital image. In particular, in some embodiments, a digital object includes an organic or non-organic object depicted in a digital image. To illustrate, in some cases, a digital object includes, but is not limited to, a person, an animal, a building, a plant, a vehicle, a piece of furniture, or a handheld item.

Additionally, as shown in FIG. 2A, the digital image 202 does not include an object shadow for the digital object 204. In one or more embodiments, an object shadow includes a shadow associated with a digital object. In particular, in some embodiments, an object shadow includes a shadow that is cast by a digital object within a digital image. For example, in some cases, an object shadow includes a shadow that is cast from a digital object across one or more surfaces (e.g., surfaces of a background) portrayed in the corresponding digital image. In some embodiments, an object shadow includes a shadow that is cast in accordance with the lighting conditions of the digital image. In some implementations, an object shadow includes a shadow that was captured along with the digital object. In some instances, however, an object shadow includes a shadow that is generated and associated with the digital object so that it appears to be cast by the digital object in accordance with the lighting conditions of the digital image.

In one or more embodiments, the lack of an object shadow is due to the nature of the digital image 202. For instance, in some cases, the digital object 204 was edited into the digital image 202 (e.g., via an image composition process or other editing process); therefore, the digital object 204 does not appear under the lighting conditions originally associated with the digital image 202 when captured. In some cases, the digital image 202 is composed of elements (including the digital object 204) manually edited together from various pre-configured image elements (e.g., computer-generated elements); therefore, the digital image 202 was created without lighting conditions at all.

As further illustrated by FIG. 2A, the digital image 202 portrays the digital object 204 against a background 206. In one or more embodiments, a background of a digital image includes portions of the digital image that are unoccupied by one or more digital objects portrayed in the digital image. In some instances, however, the background of a digital image includes portions of the digital image that are unoccupied by a targeted digital object. Indeed, in some cases, the height-based shadowing system 106 targets a particular digital object portrayed in a digital image (e.g., for generating an object shadow) and considers the remaining portions of the digital image to be part of the background. Thus, in some cases, the height-based shadowing system 106 considers a digital object portrayed in a digital image to be part of the background when targeting another digital object portrayed in the digital image for some process, such as generating an object shadow.

The background 206 shown in FIG. 2A includes a non-planar background. In one or more embodiments, a non-planar background includes a background that is defined by or composed of multiple planes. Indeed, in some embodiments, a non-planar background includes a background that is not lying or confined within a single plane. For example, in some cases, a non-planar background includes a single surface that is associated with multiple planes. In some implementations, a non-planar background includes multiple surfaces where at least one surface is associated with a different plane than at least one other surface. To illustrate, the background 206 of the digital image 202 includes a ground surface associated with a first plane and a wall surface associated with a second plane.

As shown in FIG. 2A, the height-based shadowing system 106 modifies the digital image 202 to include an object shadow 208 for the digital object 204. In particular, as shown, the object shadow 208 includes a hard object shadow. Indeed, in some implementations, an object shadow includes a hard object shadow or a soft object shadow. In one or more embodiments, a hard object shadow includes an object shadow having hard boundaries. In particular, in some embodiments, a hard object shadow includes an object shadow having boundaries that are clearly defined. For example, in some cases, a clear distinction exists between every portion (e.g., every edge) of a hard object shadow and the surrounding area. In contrast, in one or more embodiments, a soft object shadow includes an object shadow having one or more soft boundaries. In particular, in some embodiments, a soft object shadow includes an object shadow having one or more boundaries that are not clearly defined (e.g., blend into the surrounding area). For instance, in some cases, a soft object shadow includes an object shadow having at least a portion that appears to gradually fade into the surrounding area.

As illustrated, the height-based shadowing system 106 generates the object shadow 208 for inclusion within the digital image 202 using a height prediction neural network 210 and a hard shadow rendering model 212. For example, in one or more embodiments, the height-based shadowing system 106 utilizes the height prediction neural network 210 to generate height maps for the digital object 204 and the background 206 of the digital image 202. Further, the height-based shadowing system 106 utilizes the hard shadow rendering model 212 to generate the object shadow 208 based on the height maps. Generating height maps and object shadows using the height maps will be discussed in more detail below.

Though FIG. 2A illustrates the height-based shadowing system 106 generating an object shadow across a non-planar background, it should be understood that the height-based shadowing system 106 generates object shadows across various background types (including planar backgrounds) in various embodiments. Indeed, in one or more embodiments, the height-based shadowing system 106 generalizes the shadow rendering process utilizing the methods and models described herein to be compatible with a wide variety of shadow receivers. Accordingly, the height-based shadowing system 106 generates object shadows across different backgrounds—including non-planar backgrounds—providing an advantage over conventional systems, which typically cannot render shadows across such backgrounds.

FIG. 2B illustrates an overview diagram of the height-based shadowing system 106 employing various models to generate an object shadow for a digital image in accordance with one or more embodiments. As shown in FIG. 2B, the height-based shadowing system 106 utilizes a height prediction neural network 222 to analyze a digital image 220.

In one or more embodiments, a neural network includes a type of machine learning model, which can be tuned (e.g., trained) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on a plurality of inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial neural network, a graph neural network, or a multi-layer perceptron. In some embodiments, a neural network includes a combination of neural networks or neural network components.

In one or more embodiments, a height prediction neural network includes a computer-implemented neural network that generates height maps for digital images. In particular, in some embodiments, a height prediction neural network includes a neural network that analyzes a digital image and generates a height map for the digital image. For example, in some instances, the height prediction neural network analyzes one or more digital objects portrayed in a digital image and generates a height map (or multiple height maps) for the one or more digital objects. In some implementations, the height prediction neural network analyzes a background portrayed in a digital image and generates a height map (or multiple height maps) for the background. In some cases, the height prediction neural network analyzes the digital image (e.g., the one or more digital objects) by analyzing one or more masks, one or more cutouts, and/or one or more coordinate schemes associated with the digital image.

Indeed, as shown in FIG. 2B, the height-based shadowing system 106 utilizes the height prediction neural network 222 to generate height maps 228 based on the analysis of the digital image 220. In particular, the height-based shadowing system 106 utilizes the height prediction neural network 222 to generate an object height map 230 for a digital object 224 portrayed in the digital image 220. Further, the height-based shadowing system 106 utilizes the height prediction neural network 222 to generate a background height map 232 for a background 226 portrayed in the digital image 220.

In one or more embodiments, a height map includes a map of pixels to their corresponding pixel heights. In particular, in some embodiments, a height map includes a map indicating the pixel heights of pixels associated with one or more portions of a digital image. In some cases, a height map includes a one channel map having a single value for each represented pixel that indicates the pixel height of that pixel. In one or more implementations, the height map indicates pixel heights of pixels from a horizon line, ground surface, or other point of reference in the digital image.

In one or more embodiments, an object height map includes a height map indicating the pixel heights of pixels associated with one or more digital objects portrayed in a digital image. Similarly, in one or more embodiments, a background height map includes a height map indicating the pixel heights of pixels associated with a background portrayed in a digital image.

In one or more embodiments, a pixel height includes a height of a pixel within a digital image. In particular, in some embodiments, a pixel height includes a value or measurement that indicates a vertical distance of a pixel of a digital image from another point, such as another pixel of the digital image. To illustrate, in some implementations, a pixel height includes a measurement indicating the vertical distance of a pixel within a digital image with respect to a ground surface associated with (e.g., portrayed in) the digital image as measured in pixels.

As indicated, in some cases, the height-based shadowing system 106 utilizes the height prediction neural network 222 to generate the height maps 228 by analyzing the digital image 220. For instance, in some embodiments, the height prediction neural network 222 analyzes various components that correspond to the digital image 220 (e.g., components that are either included in, derived from, or otherwise associated with the digital image 220) and generates the height maps 228 based on the analysis as will be described in more detail below.

Though FIG. 2B shows generating the height maps 228 using the height prediction neural network 222, the height-based shadowing system 106 obtains the height maps 228 from various sources in different embodiments. For instance, in some cases, the height-based shadowing system 106 utilizes a three-dimensional model (e.g., a model rendering a three-dimensional scene that corresponds to the scene captured in the digital image 220) to generate the height maps 228. In some cases, the height-based shadowing system 106 receives height maps created via user input. For instance, in some implementations, the height-based shadowing system 106 receives user input providing pixel heights and creates the height maps 228 in response. In some embodiments, the height-based shadowing system 106 receives pre-generated height maps from a client device.

As further shown in FIG. 2B, the height-based shadowing system 106 utilizes a hard shadow rendering model 234 to generate a hard object shadow 236 for the digital object 224 from the height maps 228. In one or more embodiments, a hard shadow rendering model includes a computer-implemented model or algorithm that generates a hard object shadow for a digital object portrayed in a digital image. In particular, in some embodiments, a hard shadow rendering model includes a computer-implemented model that determines shadow projections of pixels of a digital object portrayed in a digital image and generates a hard object shadow based on those shadow projections. For instance, in some embodiments, a hard shadow rendering model determines, for a given pixel, a corresponding shadow projection. In some cases, the hard shadow rendering model determines a shadow projection of a pixel by determining a position of a corresponding shadow pixel.

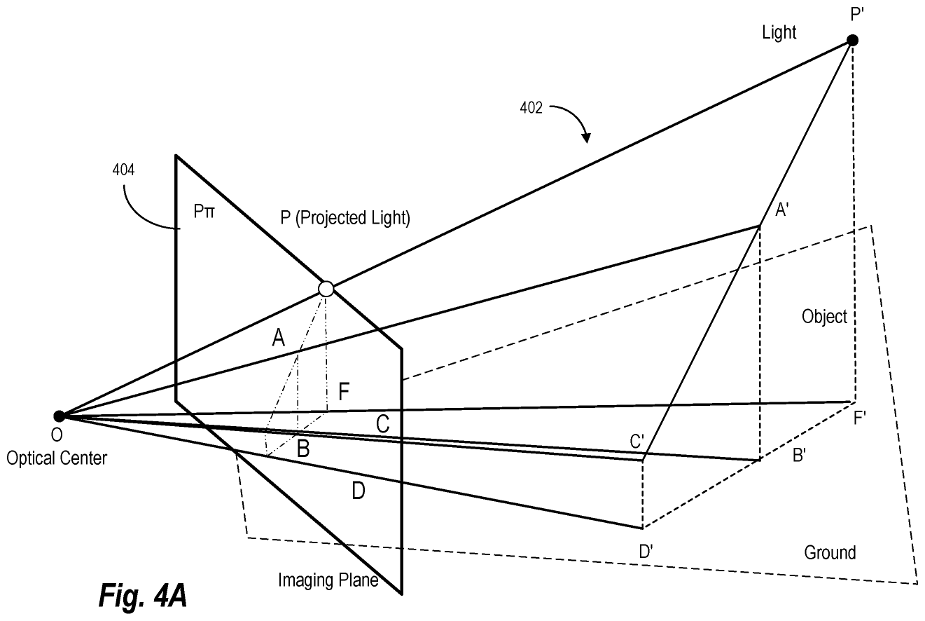

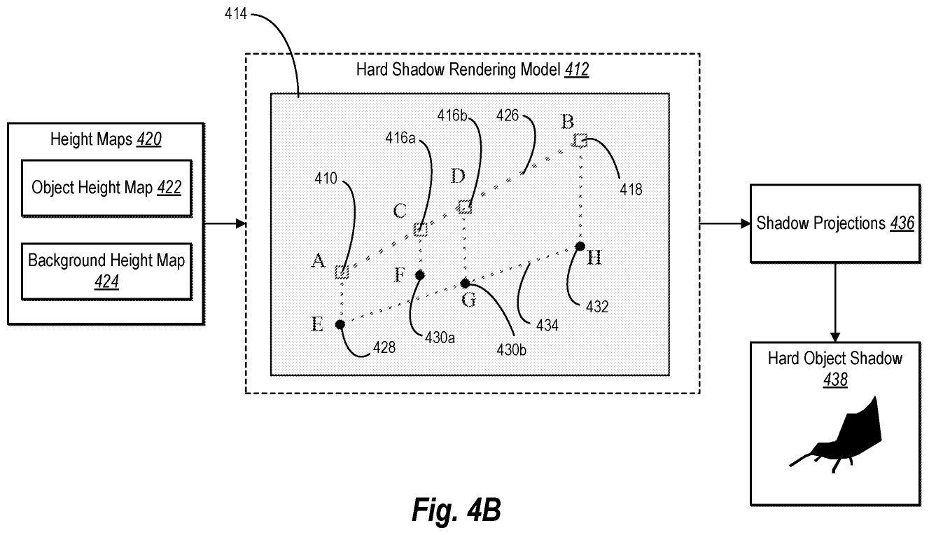

In one or more embodiments, a shadow projection includes a projection of a shadow of one portion of a digital image onto another portion of a digital image based on lighting conditions associated with the digital image. For instance, in some cases, a shadow projection includes a projection of a shadow of a digital object (i.e., an object shadow) across one or more surfaces of a digital image due to associated lighting conditions. In some implementations, a shadow projection more specifically refers to the projection of a shadow of an individual pixel. Thus, in some cases, a collection of shadow projections for individual pixels (e.g., pixels of a digital object) correspond to an object shadow of a digital object. In some cases, a shadow projection includes a location of the object shadow corresponding to a digital object (e.g., the locations for its individual shadow pixels). In some cases, a shadow projection includes one or more other qualities of an object shadow, such as its orientation, size, boundaries, etc. In some instances, the height-based shadowing system determines these other qualities based on the locations of the individual shadow pixels. Determining shadow projections will be discussed in more detail below with regard to FIGS. 4A-4B.

In one or more embodiments, a shadow pixel includes a pixel of a digital image associated with an object shadow. In particular, in some embodiments, a shadow pixel includes a pixel that portrays or contributes to the portrayal of an object shadow. As will be discussed below, in one or more embodiments, the height-based shadowing system 106 identifies, generates, or otherwise determines shadow pixels of an object shadow from a shadow projection of a corresponding digital object (e.g., from the shadow projections of the pixels of the digital object).

Indeed, as shown in FIG. 2B, the height-based shadowing system 106 utilizes the hard shadow rendering model 234 to generate the hard object shadow 236 from the height maps 228 based on light source information 238 associated with the digital image 220. In one or more embodiments, the light source information 238 represents the lighting conditions associated with the digital image 220. For instance, in some cases, the light source information 238 includes a positioning of the light source of the digital image 220 (whether the light source is portrayed within the digital image or is positioned outside the scene portrayed within the digital image). In some implementations, the light source information 238 further includes information, such as the position of the horizon within the digital image 220.

As illustrated by FIG. 2B, the height-based shadowing system 106 modifies the digital image 220 to include the hard object shadow 236. For example, in some cases, the height-based shadowing system 106 modifies pixels of the digital image 220 to become shadow pixels in accordance with the hard object shadow 236. Though FIG. 2B indicates that generating the hard object shadow 236 and modifying the digital image 220 involve separate processes, the height-based shadowing system 106 performs these processes together in some implementations. Indeed, in some cases, the height-based shadowing system 106 modifies the digital image 220 by creating the hard object shadow 236 within the digital image 220.

By utilizing an object height map and a background height map to generate a hard object shadow for a digital object portrayed in a digital image, the height-based shadowing system 106 generalizes the shadow rendering process. Indeed, the height-based shadowing system 106 generates object shadows for a more robust set of shadow receivers when compared to conventional systems, which are typically limited to planar surfaces.

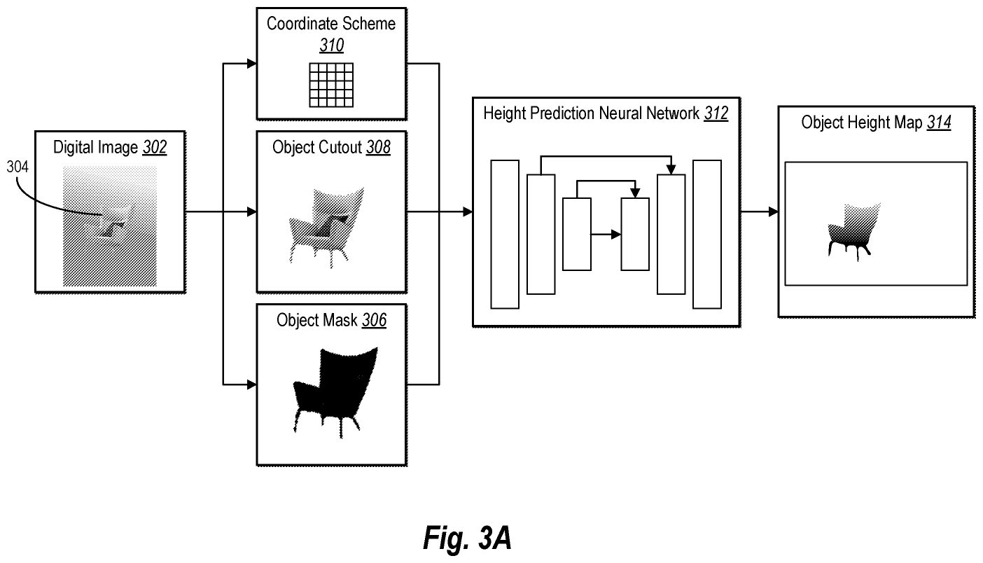

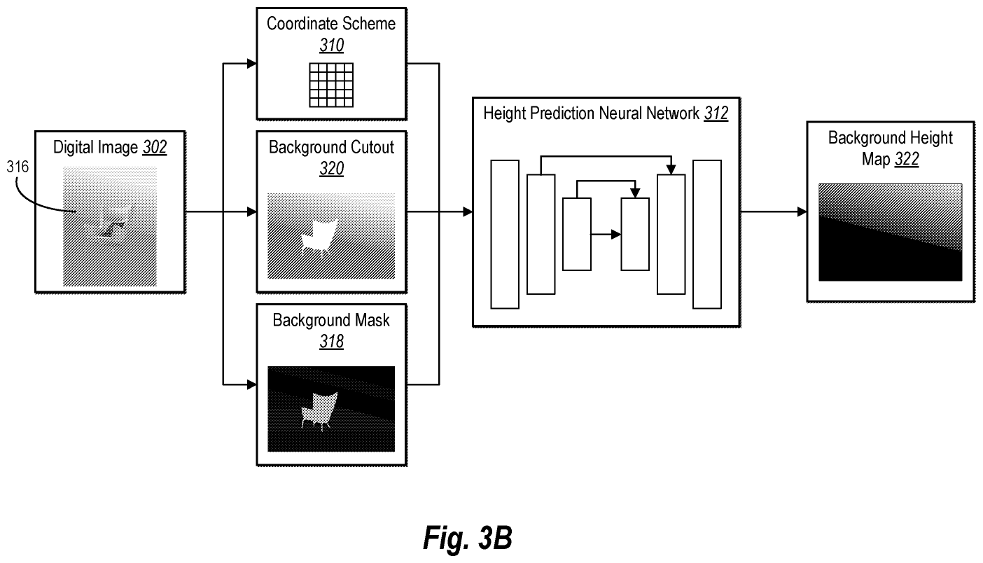

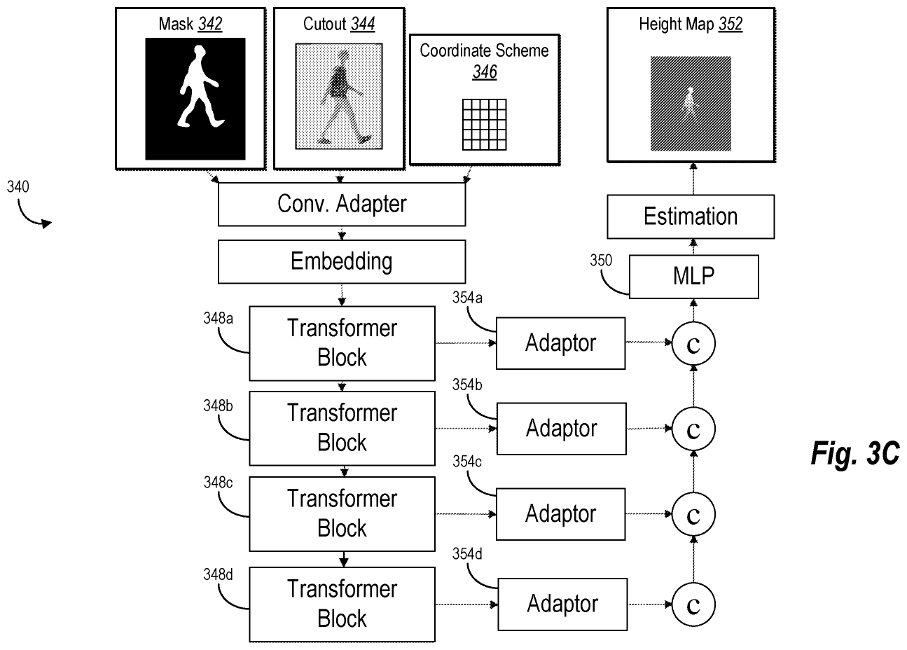

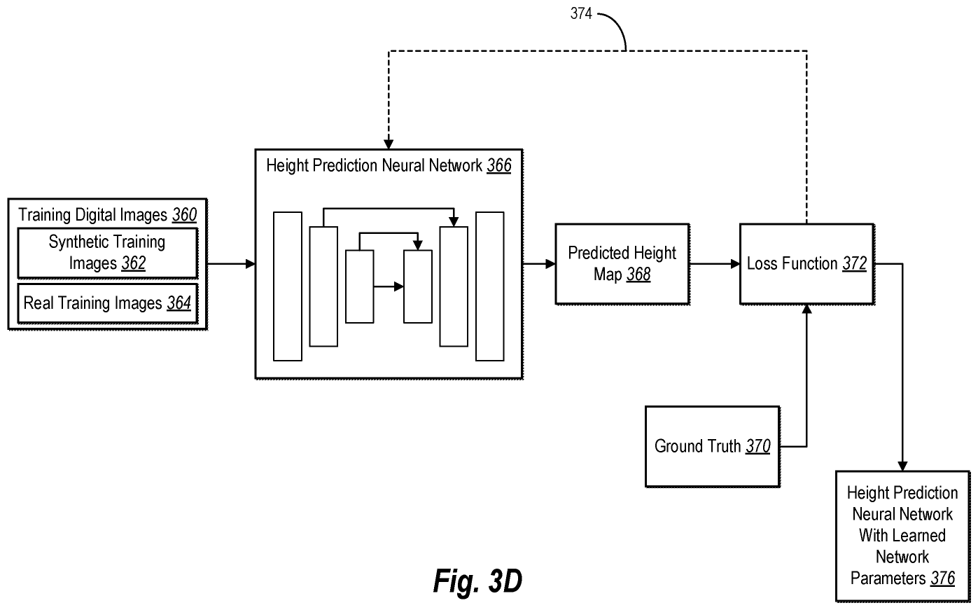

As previously mentioned, in one or more embodiments, the height-based shadowing system 106 utilizes a height prediction neural network to generate an object height map for a digital object portrayed in a digital image. FIG. 3A illustrates a diagram for using a height prediction neural network to generate an object height map for a digital object portrayed in a digital image in accordance with one or more embodiments.

As shown in FIG. 3A, the height-based shadowing system 106 determines various components that correspond to a digital image 302 that portrays a digital object 304 for use in generating an object height map 314 for the digital object 304. For instance, as illustrated in FIG. 3A, the height-based shadowing system 106 extracts an object mask 306 corresponding to the digital object 304 from the digital image 302. For example, in one or more embodiments, the height-based shadowing system 106 extracts the object mask 306 from the digital image 302 utilizing a segmentation model described in U.S. patent application Ser. No. 16/988,408 filed on Aug. 7, 2020, entitled GENERATING REFINED SEGMENTATION MASKS BASED ON UNCERTAIN PIXELS or the segmentation model described in U.S. patent application Ser. No. 17/200,525 filed on Mar. 12, 2021, entitled GENERATING REFINED SEGMENTATION MASKS VIA METICULOUS OBJECT SEGMENTATION, both of which are incorporated herein by reference in their entirety.

As further shown in FIG. 3A, the height-based shadowing system 106 determines an object cutout 308 for the digital object 304. In one or more embodiments, the height-based shadowing system 106 determines the object cutout 308 by applying the object mask 306 to the digital image 302. In some cases, the height-based shadowing system 106 receives the object cutout 308 via user input. For example, in at least one implementation, the height-based shadowing system 106 receives the object cutout 308 from a client device that extracts the object cutout 308 from the digital image 302 via user interactions with a snipping tool.

Additionally, as shown, the height-based shadowing system 106 determines a coordinate scheme 310 for the digital image 302. In one or more embodiments, a coordinate scheme includes a standard of coordinate points associated with a digital image. In particular, in some embodiments, a coordinate scheme includes a map of pixels of a digital image to coordinate points. In one or more embodiments, a coordinate scheme establishes an origin point at one of the corners of the digital image, at a center of the digital image, or at another portion of the digital image. In some cases, a coordinate scheme includes a two-dimensional coordinate scheme that is associated with a two-dimensional digital image. In some implementations, a coordinate scheme includes an indication of a y-axis associated with a digital image (e.g., orientation of the y-axis and/or direction of increasing/decreasing value for the y-axis).

In some cases, the height-based shadowing system 106 utilizes, as the coordinate scheme 310, a default or pre-determined coordinate scheme. In some implementations, the height-based shadowing system 106 determines the coordinate scheme 310 based on user input (e.g., received from a client device) or pre-configured user preferences.

As illustrated by FIG. 3A, the height-based shadowing system 106 utilizes a height prediction neural network 312 to generate the object height map 314. In one or more embodiments, the height prediction neural network 312 includes a neural network having an encoder-decoder neural network architecture. To illustrate, in some embodiments, the height prediction neural network 312 utilizes an encoder to encode the neural network inputs (e.g., the object mask 306, the object cutout 308, and the coordinate scheme 310) and utilizes the decoder to generate a neural network output (e.g., the object height map 314) from the encoded inputs. In some implementations, the height prediction neural network 312 further includes one or more skip links with each skip link providing the output of at least one layer of the encoder (e.g., an internal layer) to at least one layer of the decoder.

Similarly, as mentioned, in one or more embodiments, the height-based shadowing system 106 utilizes a height prediction neural network to generate a background height map for a background portrayed in a digital image. FIG. 3B illustrates a diagram for using a height prediction neural network to generate a background height map for a background portrayed in a digital image in accordance with one or more embodiments.

As shown in FIG. 3B, similar to generating the object height map 314 as discussed above with reference to FIG. 3A, the height-based shadowing system 106 determines various components that correspond to the background 316 of the digital image 302 for use in generating a background height map 322 for the background 316. For instance, as illustrated in FIG. 3B, the height-based shadowing system 106 generates a background mask 318 corresponding to the background 316 from the digital image 302. In one or more embodiments, the height-based shadowing system 106 generates the background mask 318 by extracting the background mask 318 directly from the digital image 302. In some cases, the height-based shadowing system 106 generates the background mask 318 by inverting the object mask 306 extracted from the digital image 302. As further shown in FIG. 3B, the height-based shadowing system 106 determines a background cutout 320 for the background 316.

As further shown, the height-based shadowing system 106 determines the coordinate scheme 310 for the digital image 302. Indeed, in one or more embodiments, the height-based shadowing system 106 utilizes the coordinate scheme 310 to generate the object height map 314 as well as the background height map 322. In some implementations, however, the height-based shadowing system 106 utilizes a different coordinate scheme to generate the background height map 322. Additionally, as illustrated by FIG. 3B, the height-based shadowing system 106 utilizes the height prediction neural network 312 to generate the background height map 322 from the background mask 318, the background cutout 320, and the coordinate scheme 310.

FIG. 3C illustrates an architecture of a height prediction neural network 340 used by the height-based shadowing system 106 for generating height maps for digital objects and backgrounds portrayed in digital images in accordance with one or more embodiments. As previously mentioned, and as shown in FIG. 3C, the height-based shadowing system 106 provides a mask 342 (e.g., an object mask or a background mask), a cutout 344 (e.g., an object cutout or a background cutout), and a coordinate scheme 346 as input to the height prediction neural network 340. For instance, in some cases, the height-based shadowing system 106 combines (e.g., concatenates) the mask 342, the cutout 344, and the coordinate scheme 346 and provides the combination to the height prediction neural network 340. In some cases, the height-based shadowing system 106 normalizes the coordinate scheme 346 by setting the lowest point in the mask 342 to be zero.

As shown in FIG. 3C, the height prediction neural network 340 includes a transformer backbone consisting of transformer blocks 348a-348d. Though a particular number of transformer blocks are shown, the height prediction neural network 340 can include various numbers of transformer blocks in other embodiments. The height prediction neural network 340 encodes the combination of the mask 342, the cutout 344, and the coordinate scheme 346 and generates or extracts features from the combination. More specifically, as shown, the height prediction neural network 340 generates features at different scales using the various transformer blocks. In one or more embodiments, a feature includes a characteristic extracted from an input (e.g., image or concatenation of an image with other inputs) by a neural network. For example, in some cases, features include deep or latent characteristics that are not readily comprehendible by a human or patent features that are visibly observable. In some embodiments, a feature map includes a collection of one or more features. For instance, in some cases, a feature map includes a grid, a matrix, a vector, or a different multi-dimensional collection of features. In addition, in some instances, a feature map includes positions or places for individual feature values that make up a feature map. For example, in some case, a feature map includes feature values corresponding to pixels of a digital image such that the feature map represents the digital image in feature-value form.

As further shown in FIG. 3C, the height prediction neural network 340 includes a multi-level decoder 350. The height prediction neural network 340 utilizes the multi-level decoder 350 to merge features from different scales. For example, in one or more implementations, each transformer block generates a feature map at a given scale (i.e., size). In one or more implementations, the feature maps are progressively smaller in scale and more abstract or latent. In some cases, the adaptors 354a-354d rescale the feature maps to a common size to allow for concatenation. The concatenated feature maps are decoded by the multi-level decoder 350 to generate the height map 352.

In one or more implementations, the use of the mask 342 allows the height prediction neural network 340 to encode only the portion of the image including the object or background for which the height map is to be generated. In other words, the use of the mask 342 allows the height prediction neural network 340 to efficiently generate the height map by ignoring other portions of the image. Thus, the height-based shadowing system 106 generates a height map for a digital object and/or background portrayed in a digital image. In particular, in some embodiments, the height-based shadowing system 106 utilizes a height prediction neural network to generate the height map(s).

In one or more embodiments, the height-based shadowing system 106 generates (e.g., trains) a height prediction neural network to generate height maps for digital objects and/or backgrounds portrayed in digital images. FIG. 3D illustrates a diagram for generating a height prediction neural network to generate height maps in accordance with one or more embodiments.

Indeed, as shown in FIG. 3D, the height-based shadowing system 106 utilizes training digital images 360 for generating a height prediction neural network 366. In particular, as shown in FIG. 3D, the training digital images 360 include synthetic training images 362 and real training images 364. In one or more embodiments, the synthetic training images 362 include computer-generated digital images. For instance, in some cases, the synthetic training images 362 include computer-generated three-dimensional models of digital objects and/or backgrounds. In some cases, the synthetic training images 362 include various poses for each of the generated three-dimensional models. For each pose of a three-dimensional model, the synthetic training images 362 include images captured from different angles. In some implementations, the real training images 364 includes photographs (e.g., digital photographs).

As illustrated in FIG. 3D, the height-based shadowing system 106 utilizes the height prediction neural network 366 to analyze a training digital image from the training digital images 360 (e.g., one of the synthetic training images 362 or the real training images 364) and generate a predicted height map 368 based on the analysis. Further, the height-based shadowing system 106 compares the predicted height map 368 to a ground truth 370 via a loss function 372.

In one or more embodiments, the ground truths corresponding to the synthetic training images 362 include the pixel heights of the three-dimensional models of the digital objects and/or the backgrounds depicted in the synthetic training images 362. For instance, in some cases, the ground truths corresponding to the synthetic training images 362 include masks corresponding to two-dimensional images captured from the posed three-dimensional models and the pixel heights for the pixels represented within the masks.

Further, in some embodiments, the ground truths corresponding to the real training images 364 include one or more annotations for the digital objects and/or the backgrounds depicted in the real training images 364. To illustrate, in one or more embodiments, the ground truth corresponding to each real training image includes one or more labels (e.g., annotations) provided via user interaction, where a label includes a line drawn from a point of a digital object or background portrayed in the real training image to a point on the ground surface portrayed in the real training image. In particular, in some cases, each label shows the projection of a point from the digital object or background to the ground surface. In one or more embodiments, the ground truth corresponding to each real training image further includes a measurement of the length of each line (e.g., the pixel height corresponding to the drawn line). In some cases, the ground truths further include dense pixel heights maps for the digital objects and/or the backgrounds determined via bi-linear interpolation using the annotations.

In one or more embodiments, the height-based shadowing system 106 compares the predicted height map 368 to the ground truth 370 to determine a loss (i.e., an error) of the height prediction neural network 366. In some embodiments, where the ground truth 370 corresponds to a real training image, the height-based shadowing system 106 determines the loss corresponding to the one or more labels showing a projection of a point of the portrayed digital object or background to the ground surface.

As shown in FIG. 3D, the height-based shadowing system 106 back propagates the determined loss to the height prediction neural network 366 (as shown by the dashed line 374) to update the parameters of the height prediction neural network 366. In particular, the height-based shadowing system 106 updates the parameters to minimize the error of the height prediction neural network 366 in generating height maps for digital objects and/or backgrounds portrayed in digital images.

Though FIG. 3D illustrates generating the height prediction neural network 366 using one refinement iteration, it should be noted that, in some embodiments, the height-based shadowing system 106 generates the height prediction neural network 366 using multiple refinement iterations. In one or more embodiments, with each iteration of refinement, the height-based shadowing system 106 gradually improves the accuracy with which the height prediction neural network 366 generates height maps for digital objects and/or backgrounds. Thus, the height-based shadowing system 106 generates the height prediction neural network with learned network parameters 376.

Indeed, as shown in FIG. 3D, the height-based shadowing system 106 generates a height prediction neural network using synthetic training images and real training images. In some cases, however, the height-based shadowing system 106 generates the height prediction neural network using only synthetic training images or only real training images. In some implementations, generating a height prediction neural network from both synthetic training images and real training images improves the ability of the height prediction neural network to generate height maps. For instance, in some cases, using synthetic training images and real training images reduces the artifacts present in the height maps that are generated by the height prediction neural network.

As mentioned above, in one or more embodiments, the height-based shadowing system 106 utilizes an object height maps and a background height map for a digital image to determine a shadow projection of a digital object portrayed therein. In particular, the height-based shadowing system 106 determines shadow projections for the pixels of the digital object. As further discussed, in one or more embodiments, the height-based shadowing system 106 determines the shadow projections using light source information associated with the digital image portraying the digital object. FIGS. 4A-4B illustrate diagrams for determining shadow projections for the pixels of a digital object using an object height map, a background height map, and light source information in accordance with one or more embodiments.

FIG. 4A illustrates projection correlations in accordance with one or more embodiments. In particular, FIG. 4A illustrates correlations between an object in the physical world, casting a shadow and how that object and shadow are captured within a digital image. Indeed, FIG. 4A illustrates a three-dimensional space 402. In one or more embodiments, the three-dimensional space 402 represents a physical, real-world space (or a three-dimensional space generated by a computing device) or a re-creation of such a space.

FIG. 4A also illustrates an image space portrayed within a digital image 404. In one or more embodiments, an image space includes a space defined by a digital image. In particular, in some embodiments, an image space includes a space defined by the pixels of a digital image. For example, in some cases, the height-based shadowing system 106 determines the distance between two points of a digital image in its corresponding image space as the distance in pixels. Accordingly, in one or more embodiments, the digital image 404 portrays a two-dimensional projection of the three-dimensional space 402 captured within its corresponding image space.

To illustrate, FIG. 4A includes the point A′ representing a portion of an object in the physical world. When a light source represented by the point P′ illuminates the environment of the three-dimensional space 402, the portion of the object represented by point A′ casts a shadow represented by the point C′. When the scene is captured within the digital image 404, the light source, the portion of the object, and the corresponding shadow are projected to P, A, and C, respectively. The point F′ represents the vertical projection of the light source P′ onto the ground surface, and the point F′ is projected to the point F within the digital image 404. Similarly, the point B′ represents the vertical projection of the portion of the object onto the ground surface (which is corresponds to the point B within the digital image 404) and the point D′ represents the vertical projection of the shadow cast by the portion of the object (which corresponds to the point D within the digital image 404).

It should be noted that P′, A′, and C′ are collinear while F′, B′, and D′ are also collinear. Indeed, in one or more embodiments, the height-based shadowing system 106 leverages an important observation: the collinear property is preserved after projection under the pinhole camera model assumption.

It should be further noted that the point C′ representing the shadow cast by the portion of the object of point A′ is not positioned on the ground surface of the three-dimensional space 402. In particular, the point C′ is positioned above the ground surface by a distance represented by the line C′D′, indicating that the shadow cast by the portion of the object of point A′ falls on some other surface (e.g., a wall). Accordingly, the point (within the digital image 404 is positioned above the ground surface portrayed therein by a distance represented by the line CD. As the points C and D exist within the image space of the digital image 404, the distance represented by the line CD corresponds to the pixel height of the point C. Thus, in one or more embodiments, the height-based shadowing system 106 utilizes the projections of points from a three-dimensional environment to an image space of a digital image and the relationships between those projections in generating an object shadow for a digital object portrayed within the digital object.

Further, in one or more embodiments, the height-based shadowing system 106 utilizes height maps to generate an object shadow for a digital object portrayed within a digital image in accordance with the projection correlations shown in FIG. 4A. Indeed, as mentioned above, various factors cause a digital image to not portray an object shadow for a digital object depicted therein in different embodiments. For instance, in some cases, the digital image is the result of image composition or otherwise the result of editing the digital image to include the digital object so that the scene captured by the digital image did not include the real-world object corresponding to the digital object Accordingly, in some instances, the height-based shadowing system 106 generates an object shadow to portray a shadow that would have been captured had the real-world object been present when the digital image was captured.

FIG. 4B illustrates a diagram for determining whether a pixel 410 of the background of a digital image (represented as A) corresponds to an object shadow utilizing a hard shadow rendering model 412 in accordance with one or more embodiments. Indeed, in one or more embodiments, a digital image having boundaries represented by the box 414 includes the pixel 410 of the background. In other words, the digital image portrays a background, and the pixel 410 corresponds to a portion of that background. Further, in some embodiments, the digital image portrays a digital object that includes at least pixels 416a-416b (represented as C and D, respectively).

Accordingly, in some implementations, the height-based shadowing system 106 determines whether the pixel 410 of the background corresponds to an object shadow for the digital object by determining whether the pixel 410 is blocked from receiving light from a light source 418 (represented as B) associated with the digital image. In particular, the height-based shadowing system 106 determines whether the digital object (e.g., at least one pixel of the digital object) is blocking the pixel 410 of the background from receiving the light.

In one or more embodiments, to determine whether the digital object is blocking the pixel 410 of the background from receiving light, the height-based shadowing system 106 identifies pixels of the digital object that are positioned between the pixel 410 of the background and the light source 418 for the digital image. To illustrate, as shown in FIG. 4B, the height-based shadowing system 106 determines a line 426 between the pixel 410 of the background and the light source 418. The height-based shadowing system 106 further identifies pixels of the digital object that are positioned on the line 426 (including the pixel 416a and the pixel 416b). Thus, in some cases, the height-based shadowing system 106 determines whether at least one pixel of the digital object that is positioned on the line 426 is blocking light from reaching the pixel 410 of the background.

As shown in FIG. 4B, the height-based shadowing system 106 utilizes height maps 420 to determine whether the pixel 410 of the background is blocked from receiving light from the light source 418. In particular, as shown, the height-based shadowing system 106 utilizes an object height map 422 generated for the digital object and a background height map 424 generated for the background portrayed within the digital image. In one or more embodiments, the height-based shadowing system 106 utilizes the height maps 420 by utilizing the pixel heights represented in the height maps 420 to determine the ground points corresponding to the pixels represented therein.

In one or more embodiments, a ground point includes a point on a ground surface. In particular, in some embodiments, a ground point includes a point on a ground surface that corresponds to another point positioned on a surface other than the ground surface. For instance, in some cases, a ground point includes a projection of another point onto a ground surface. To illustrate, further, in some implementations, a ground point includes a projection (e.g., a vertical projection) of a pixel onto a ground surface within an image space of a digital image.

To illustrate, as shown in FIG. 4B, the height-based shadowing system 106 determines a ground point 428 (represented as E) that corresponds to the pixel 410 of the background. For instance, in some cases, the height-based shadowing system 106 determines the ground point 428 utilizing the background height map 424. Similarly, as shown, the height-based shadowing system 106 determines a ground point 430a (represented as F) corresponding to the pixel 416a and a ground point 430b (represented as G) corresponding to the pixel 416b of the digital object, such as by using the object height map 422. Further, the height-based shadowing system 106 determines a ground point 432 (represented as H) corresponding to the light source 418 of the digital image.

As further illustrated in FIG. 4B, the height-based shadowing system 106 determines a line 434 between the ground point 428 corresponding to the pixel 410 of the background and the ground point 432 corresponding to the light source 418. As suggested by FIG. 4B, the line 434 is a projection of the line 426 onto the ground surface of the digital image.

As mentioned, in one or more embodiments, the height-based shadowing system 106 determines whether the pixel 410 of the background corresponds to the object shadow by determining whether at least one pixel of the digital object that is positioned on the line 426 is blocking light from reaching the pixel 410 of the background. In one or more embodiments, the height-based shadowing system 106 determines whether a pixel of the digital object positioned on the line 426 is blocking light from reaching the pixel 410 of the background by determining whether a pixel of the digital object positioned on the line 426 has a corresponding ground point that is positioned on the line 434.

For example, as shown in FIG. 4B, the height-based shadowing system 106 determines that the ground point 430a corresponding to the pixel 416a is not positioned on the line 434. Accordingly, the height-based shadowing system 106 determines that the pixel 416a is not blocking light from reaching the pixel 410 of the background. As further shown, however, the height-based shadowing system 106 determines that the ground point 430b corresponding to the pixel 416b is positioned on the line 434. Thus, the height-based shadowing system 106 determines that the pixel 416b is blocking light from reaching the pixel 410 of the background, and the pixel 410 corresponds to (e.g., is part of) the object shadow of the digital object. In other words, the height-based shadowing system 106 determines that the pixel 410 of the background corresponds to a shadow projection of the pixel 416b of the digital object. In one or more embodiments, based on determining that the pixel 410 of the background corresponds to a shadow projection, the height-based shadowing system 106 modifies the pixel 410 to include a shadow pixel. In one or more embodiments, the height-based shadowing system 106 utilizes a tolerance value to determine whether a ground point corresponding to a pixel of the digital object is positioned on the line 434.

In one or more embodiments, the height-based shadowing system 106 similarly identifies one or more additional pixels of the background that correspond to the object shadow of the digital object. In some cases, the height-based shadowing system 106 analyzes each pixel of the background to determine whether that pixel corresponds to the object shadow. In some implementations, the height-based shadowing system 106 analyzes a subset of the pixels of the background (e.g., a subset that are relatively more likely to correspond to the object shadow, such as a subset of pixels of the background that are on an opposite side of the digital object than the light source 418).

Indeed, in one or more embodiments, for a given pixel of the background, the height-based shadowing system 106 determines a line between that pixel and the light source for the digital image. Additionally, the height-based shadowing system 106 identifies pixels of the digital object that are positioned on that line. The height-based shadowing system 106 further determines corresponding ground points for the pixel of the background, the identified pixel(s) of the digital object, and the light source (e.g., using the relevant height map). The height-based shadowing system 106 determines an additional line between the ground point of the pixel of the background and the ground point of the light source and determines whether at least one of the ground points of the pixels of the digital object are positioned on that additional line. If so, the height-based shadowing system 106 determines that the pixel of the background corresponds to a shadow projection of that pixel of the digital object and modifies that pixel of the background to include a shadow pixel. In some cases, upon determining that the pixel of the background does not correspond to a shadow projection of a pixel of the digital object, the height-based shadowing system 106 maintains an initial value of the pixel of the background (e.g., does not modify the pixel to include a shadow pixel).

In one or more embodiments, the height-based shadowing system 106 iterates through each pixel of the digital object positioned on the line between the pixel of the background and the light source to identify any of those pixels that are blocking light. In some cases, the height-based shadowing system 106 stops iterating as soon as one light-blocking pixel of the digital object is identified.

Thus, as shown in FIG. 4B, the height-based shadowing system 106 determines shadow projections 436 of the pixels of the digital object (e.g., a shadow projection of the digital object itself). Based on the shadow projections 436, the height-based shadowing system 106 generates a hard object shadow 438 for the digital object. In one or more embodiments, the height-based shadowing system 106 additionally or alternatively generates a hard shadow mask that corresponds to the hard object shadow 438 for the digital object.

The back tracing pixel height based hard shadow rendering (BT-PHSR) algorithm presented below represents another characterization of the height-based shadowing system 106 determining shadow projections of pixels of a digital object portrayed in a digital image for rendering a hard object shadow in accordance with one or more embodiments.

### BT-PHSR Algorithm

```
Input: Shadow occluder pixel height map H, light position l_{xy} and height
hₗ, shadow receiver pixel height map R
Output: Hard Shadow S
Initialize S with 1, ∈ with 1
h, w = height and width of H
for i = 0 to w do
  for j = 0 to h do
    pᵢⱼ = (i,j)
    hᵣ = R(i,j)
    for all p on the line l_{xy} − pᵢⱼ do
      i′,j′ = p
      if H(i′,j′) does not have value, then
        Continue
      else
        h′ = H(i′,j′)
        h = (hₗ − hᵣ) · (p − pᵢⱼ)/(l_{xy} − pᵢⱼ)
        if |h − h′| < ∈ then
          S(i,j) = 0
          Break
        end
      end
    end
  end
end
```

As indicated by the BT-PHSR algorithm, in one or more embodiments, the height-based shadowing system 106 analyzes pixels of the digital object (i.e., the shadow occluder) on the line between the light source and another pixel. Upon determining that the other pixel is blocked from receiving light, the height-based shadowing system 106 modifies the set of hard shadow pixels (represented as S) to include the other pixel.

By using the methods described above to analyze pixels of a digital image in an image space, the height-based shadowing system 106 determines whether pixels of the background receive light within a corresponding three-dimensional space. In particular, in some cases, by determining whether a ground point for a pixel of a digital object is positioned on a line connecting ground points for a pixel of the background and a light source within an image space, the height-based shadowing system 106 determines whether the corresponding portion of the digital object is directly between the corresponding portion of the background and the light source within the three-dimensional space. As mentioned, and as shown in FIG. 4B and the BT-PHSR algorithm, the height-based shadowing system 106 utilizes a background height map (i.e., the shadow receiver pixel height map R) and an object height map (i.e., the shadow occluder pixel height map H) in identifying the ground points used in determining whether a particular pixel has access to light. Thus, in one or more embodiments, the height-based shadowing system 106 utilizes height maps in generating a hard object shadow for a digital object.

By using the height maps, the height-based shadowing system 106 operates more flexible when compared to conventional systems as it generates hard object shadows for a more robust set of shadow receivers, including those shadow receivers having non-planar surfaces. As such, the height-based shadowing system 106 further operates more accurately when compared to conventional systems. Indeed, by implementing a hard shadow rendering approach that accommodates non-planar backgrounds, the height-based shadowing system 106 generates hard object shadows that more accurately represent the shadow projection of a digital object across such backgrounds. Thus, the resulting digital images provide a more natural, realistic appearance.

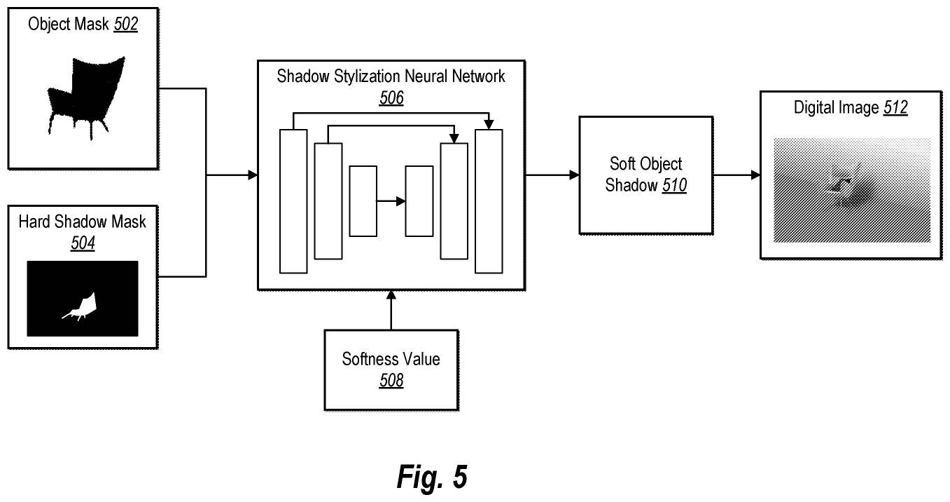

In one or more embodiments, the height-based shadowing system 106 further generates a soft object shadow for a digital object portrayed in a digital image. In particular, in some embodiments, the height-based shadowing system 106 generates a soft object shadow from a hard object shadow generated for the digital object. FIG. 5 illustrates a diagram for generating a soft object shadow for a digital object portrayed in a digital image in accordance with one or more embodiments.

Indeed, as shown in FIG. 5, the height-based shadowing system 106 provides an object mask 502 and a hard shadow mask 504 corresponding to a digital object portrayed in a digital image to a shadow stylization neural network 506. In one or more embodiments, the height-based shadowing system 106 generates the object mask 502 for the digital object as discussed above with reference to FIG. 3A. Further, in some cases, the height-based shadowing system 106 generates the hard shadow mask 504 for the digital object as discussed above with reference to FIG. 4B. As illustrated, the height-based shadowing system 106 utilizes the shadow stylization neural network 506 to generate a soft object shadow 510 from the object mask 502 and the hard shadow mask 504.

In one or more embodiments, a shadow stylization neural network includes a computer-implemented neural network that generates soft object shadows for digital objects portrayed in a digital image. In particular, in some embodiments, a shadow stylization neural network includes a neural network that generates soft object shadows based on shadow projections determined for a digital object. For instance, in some cases, a shadow stylization neural network includes a neural network that analyzes a hard shadow mask (or a hard object shadow) and an object mask for a digital object and generates a soft object shadow for the digital object based on the analysis.

In one or more embodiments, the shadow stylization neural network 506 includes a neural network having an encoder-decoder neural network architecture. To illustrate, in some embodiments, the shadow stylization neural network 506 utilizes an encoder to encode the neural network inputs (e.g., the object mask 502 and the hard shadow mask 504) and utilizes the decoder to generate a neural network output (e.g., the soft object shadow 510). In some implementations, the shadow stylization neural network 506 further includes one or more skip links with each skip link providing the output of at least one layer of the encoder to at least one layer of the decoder.

As further shown in FIG. 5, the height-based shadowing system 106 provides a softness value 508 to the shadow stylization neural network 506. Indeed, as shown, the height-based shadowing system 106 utilizes the shadow stylization neural network 506 to generate the soft object shadow 510 further based on the softness value 508. In one or more embodiments, the height-based shadowing system 106 determines the softness value 508 from user input. For example, in some cases, the height-based shadowing system 106 receives the softness value 508 from a client device or otherwise determines the softness value 508 based on user input received from a client device (e.g., based on user interactions with a softness control provided within a graphical user interface displayed on the client device). In some implementations, the height-based shadowing system 106 utilizes a pre-determined softness value, a default softness value, or a softness value determined from user preferences.

In one or more embodiments, the height-based shadowing system 106 provides the softness value 508 to the shadow stylization neural network 506 by providing the softness value 508 to one or more of the decoder layers. To illustrate, in some implementations, the height-based shadowing system 106 defines the softness value 508 as a two-dimensional feature map (e.g., a two-dimensional vector that indicates the softness of the object shadow for each shadow pixel associated with the object shadow). Further, the height-based shadowing system 106 concatenates the two-dimensional feature map with the input (or output) of one or more layers of the decoder of the shadow stylization neural network 506, such as one or more of the initial layers of the decoder. Accordingly, in some cases, the layers of the decoder analyze the softness information from the softness value 508 as it generates the soft object shadow 510.

In one or more embodiments, the height-based shadowing system 106 generates (e.g., trains) the shadow stylization neural network 506 for use in generating soft object shadows for digital objects. In some cases, the height-based shadowing system 106 generates the shadow stylization neural network 506 by utilizing multiple refinement iterations to refine its parameters and improve its accuracy in generating soft object shadows. To illustrate, in some cases, the height-based shadowing system 106 utilizes the shadow stylization neural network 506 to analyze a training object mask and a training hard shadow mask (or training hard object shadow) for a given refinement iteration. Further, the height-based shadowing system 106 provides a training softness value to the shadow stylization neural network 506. Accordingly, the height-based shadowing system 106 utilizes the shadow stylization neural network 506 to generate a predicted soft object shadow, compares the predicted soft object shadow to a ground truth via a loss function, and back propagates the determined loss to the shadow stylization neural network 506 to update its parameters.

In some cases, the height-based shadowing system 106 utilizes synthetic images to generate the shadow stylization neural network 506. In particular, the height-based shadowing system 106 utilizes training hard shadow masks and training object masks generated from synthetic training images. In some cases, the height-based shadowing system 106 utilizes real images or a combination of synthetic and real images to generate the shadow stylization neural network 506. To illustrate, in some embodiments, the height-based shadowing system 106 utilizes synthetic images composed of three-dimensional models as the training images and further utilizes a physics-based shadow rendering model to generate soft object shadows from the three-dimensional models for use as the corresponding ground truths. For instance, in some cases, the height-based shadowing system 106 utilizes the physics-based rendering model described in PBR Render, https://substance3d.adobe.com/documentation/sddoc/pbr-render-194216472.html, 2021, the entire contents of which are hereby incorporated by reference in their entirety.

In one or more embodiments, the height-based shadowing system 106 generates the shadow stylization neural network 506 simultaneously with the height prediction neural network. In some cases, however, the height-based shadowing system 106 generates each neural network via a separate process.

Further, as shown, the height-based shadowing system 106 utilizes the soft object shadow 510 generated from the shadow stylization neural network 506 to modify a digital image 512. In particular, the height-based shadowing system 106 modifies the digital image 512 to include the soft object shadow 510. For example, as shown in FIG. 5, the height-based shadowing system 106 modifies the digital image 512 so that the digital object portrayed in the digital image 512 appears to be casting the soft object shadow 510 in accordance with lighting conditions associated with the digital image 512.

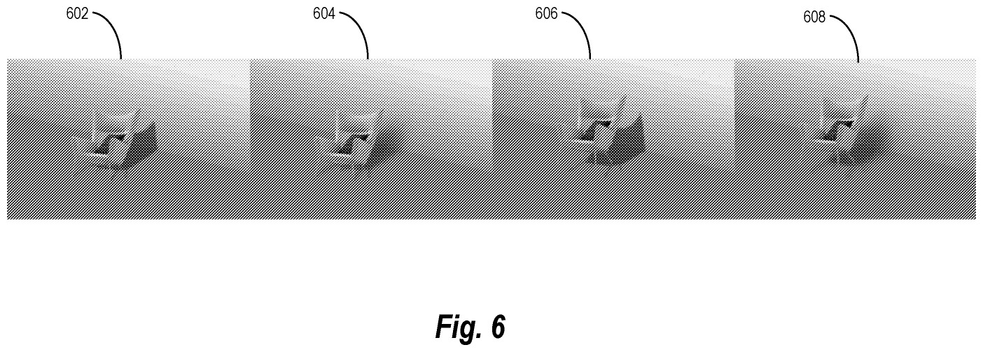

FIG. 6 illustrates example hard object shadows and soft object shadows generated by the height-based shadowing system 106 in accordance with one or more embodiments. For instance, the digital image 602 shows a hard object shadow generated for a digital object positioned on a ground surface portrayed therein. The digital image 604 shows a soft object shadow generated for the same digital object. The digital image 606 shows a hard object shadow generated for a digital object positioned (e.g., floating) above a ground surface portrayed therein, while the digital image 608 shows a soft object shadow generated for the same digital object.

Indeed, in one or more embodiments, the height-based shadowing system 106 generates object shadows for digital objects that are not positioned directly on top of a ground surface, whether due to the initial location of the digital object or some vertical movement of the digital object (e.g., in response to user input moving the digital object). In some cases, such as when the digital object has been moved, the height-based shadowing system 106 adds a shift value to the pixel heights included within the corresponding object height map. For example, in some instances, the height-based shadowing system 106 determines a shift value based on the vertical movement of the digital object and adds the shift value to the pixel heights.

To provide an example, in some cases, the height-based shadowing system 106 generates an object shadow for a digital object within a digital image utilizing corresponding height maps. The height-based shadowing system 106 further determines a vertical movement of the digital object within the digital image (e.g., in response to user input). In response, the height-based shadowing system 106 adds a shift value to the pixel heights within the object height map and modifies the object shadow within the digital image accordingly.

Turning to FIG. 7, additional detail will now be provided regarding various components and capabilities of the height-based shadowing system 106. In particular, FIG. 7 illustrates the height-based shadowing system 106 implemented by the computing device 700 (e.g., the server(s) 102 and/or one of the client devices 110a-110n discussed above with reference to FIG. 1). Additionally, the height-based shadowing system 106 is also part of the image editing system 104. As shown, in one or more embodiments, the height-based shadowing system 106 includes, but is not limited to, a height map generator 702, a hard shadow generator 704, a soft shadow generator 706, an image modification engine 708, and data storage 710 (which includes a height prediction neural network 712, a hard shadow rendering model 714, and a shadow stylization neural network 716).

As just mentioned, and as illustrated in FIG. 7, the height-based shadowing system 106 includes the height map generator 702. In one or more embodiments, the height map generator 702 generates height maps for a digital image. In particular, in some embodiments, the height map generator 702 generates an object height map for a digital object portrayed in a digital image and a background height map for a background portrayed in the digital image. In some implementations, the height map generator 702 implements a height prediction neural network to generate one or more of the height maps.

Additionally, as shown in FIG. 7, the height-based shadowing system 106 includes the hard shadow generator 704. In one or more embodiments, the hard shadow generator 704 generates hard object shadows for digital objects portrayed in digital images. For instance, in some embodiments, the hard shadow generator 704 implements a hard shadow rendering model to generate hard object shadows for digital objects. To illustrate, in some cases, the hard shadow generator 704 implements the hard shadow rendering model to generate a hard object shadow for a digital object based on an object height map for the digital object and a background height map for the corresponding background.

As shown in FIG. 7, the height-based shadowing system 106 further includes the soft shadow generator 706. In one or more embodiments, the soft shadow generator 706 generates soft object shadows for digital objects portrayed in digital images. In particular, in some embodiments, the soft shadow generator 706 generates a soft object shadow for a digital object based on a hard object shadow generated for the digital object. In some cases, the soft shadow generator 706 implements a shadow stylization neural network to generate soft object shadows.

As illustrated in FIG. 7, the height-based shadowing system 106 also includes the image modification engine 708. In one or more embodiments, the image modification engine 708 modifies digital images to include object shadows for digital objects portrayed therein. For instance, in some cases, the image modification engine 708 modifies a digital image to include a hard object shadow or a soft object shadow for a digital object portrayed therein. In some cases, the image modification engine 708 modifies the digital image by modifying relevant pixels to include shadow pixels.

Additionally, as shown in FIG. 7, the height-based shadowing system 106 includes data storage 710. In particular, data storage 710 includes the height prediction neural network 712, the hard shadow rendering model 714, and the shadow stylization neural network 716 utilized in generating object shadows for digital objects portrayed in digital images.

Each of the components 702-716 of the height-based shadowing system 106 optionally include software, hardware, or both. For example, the components 702-716 include one or more instructions stored on a computer-readable storage medium and executable by processors of one or more computing devices, such as a client device or server device. When executed by the one or more processors, the computer-executable instructions of the height-based shadowing system 106 cause the computing device(s) to perform the methods described herein. Alternatively, the components 702-716 include hardware, such as a special-purpose processing device to perform a certain function or group of functions. Alternatively, the components 702-716 of the height-based shadowing system 106 include a combination of computer-executable instructions and hardware.

Furthermore, the components 702-716 of the height-based shadowing system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 702-716 of the height-based shadowing system 106 may be implemented as a stand-alone application, such as a desktop or mobile application. Furthermore, the components 702-716 of the height-based shadowing system 106 may be implemented as one or more web-based applications hosted on a remote server. Alternatively, or additionally, the components 702-716 of the height-based shadowing system 106 may be implemented in a suite of mobile device applications or “apps.” For example, in one or more embodiments, the height-based shadowing system 106 comprises or operates in connection with digital software applications such as ADOBE® AFTER EFFECTS®, ADOBE® ILLUSTRATOR®, or ADOBE® PHOTOSHOP®. The foregoing are either registered trademarks or trademarks of Adobe Inc. in the United States and/or other countries.

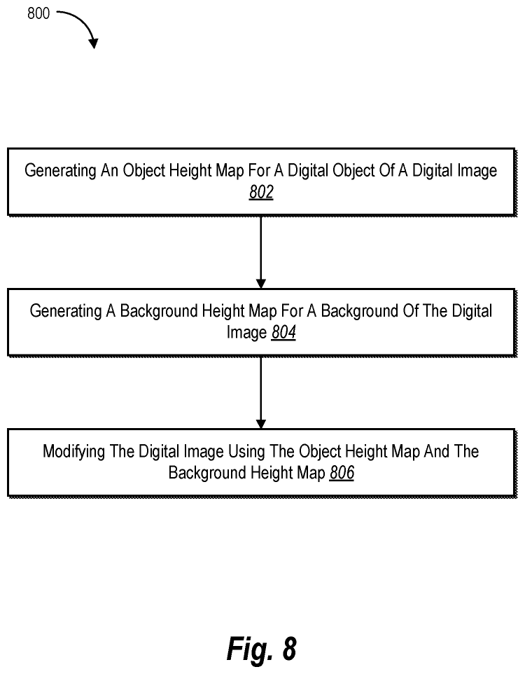

FIGS. 1-7, the corresponding text, and the examples provide a number of different methods, systems, devices, and non-transitory computer-readable media of the height-based shadowing system 106. In addition to the foregoing, one or more embodiments can also be described in terms of flowcharts comprising acts for accomplishing the particular result, as shown in FIG. 8. FIG. 8 may be performed with more or fewer acts. Further, the acts may be performed in different orders. Additionally, the acts described herein may be repeated or performed in parallel with one another or in parallel with different instances of the same or similar acts.

FIG. 8 illustrates a flowchart for a series of acts 800 for generating an object shadow for a digital object using height maps in accordance with one or more embodiments. FIG. 8 illustrates acts according to one embodiment, alternative embodiments may omit, add to, reorder, and/or modify any of the acts shown in FIG. 8. In some implementations, the acts of FIG. 8 are performed as part of a method. Alternatively, a non-transitory computer-readable medium can store executable instructions that, when executed by a processing device, cause the processing device to perform operations comprising the acts of FIG. 8. In some embodiments, a system performs the acts of FIG. 8. For example, in one or more embodiments, a system includes one or more memory components. The system further includes one or more processing devices coupled to the one or more memory components, the one or more processing devices to perform operations comprising the acts of FIG. 8.

The series of acts 800 includes an act 802 for generating an object height map for a digital object of a digital image. For example, in one or more embodiments, the act 802 involves generating, utilizing a height prediction neural network, an object height map comprising pixel heights for pixels of a digital object portrayed in a digital image.

The series of acts 800 also includes an act 804 for generating a background height map for a background of the digital image. For instance, in one or more embodiments, the act 804 involves generating, utilizing the height prediction neural network, a background height map comprising additional pixel heights for pixels of a background portrayed in the digital image.

In one or more embodiments, the height-based shadowing system 106 further extracts, from the digital image, a background mask corresponding to the background portrayed in the digital image. Accordingly, in some embodiments, generating, utilizing the height prediction neural network, the background height map comprises generating, utilizing the height prediction neural network, the background height map based on the background mask. In some cases, the height-based shadowing system 106 further determines at least one of a background cutout for the background portrayed in the digital image or a coordinate scheme for the digital image. As such, in some cases, generating, utilizing the height prediction neural network, the background height map comprises generating, utilizing the height prediction neural network, the background height map based on the background cutout or the coordinate scheme.

Further, the series of acts 800 includes an act 806 for modifying the digital image using the object height map and the background height map. To illustrate, in one or more embodiments, the act 806 involves modifying the digital image to include an object shadow for the digital object using the object height map and the background height map.

In one or more embodiments, the height-based shadowing system 106 further determines a set of ground points corresponding to the pixels of the background utilizing the additional pixel heights for the pixels of the background from the background height map. Accordingly, in some embodiments, modifying the digital image to include the object shadow for the digital object using the background height map comprises generating the object shadow for the digital object utilizing the set of ground points. In some instances, the height-based shadowing system 106 further determines an additional set of ground points corresponding to the pixels of the digital object utilizing the pixel heights for the pixels of the digital object from the object height map. As such, in some cases, modifying the digital image to include the object shadow for the digital object using the background height map comprises generating the object shadow for the digital object utilizing the additional set of ground points.

In one or more embodiments, the height-based shadowing system 106 determines that a pixel of the digital object is blocking light from reaching a pixel of the background within a three-dimensional space corresponding to the digital image utilizing the object height map and the background height map. Accordingly, in some embodiments, modifying the digital image to include an object shadow for the digital object using the object height map and the background height map comprises modifying the pixel of the background to include a shadow pixel based on determining that the pixel of the digital object is blocking the light from reaching the pixel of the background.

In some implementations, determining that the pixel of the digital object is blocking the light from reaching the pixel of the background within the three-dimensional space corresponding to the digital image utilizing the object height map and the background height map comprises: determining a ground point corresponding to the pixel of the digital object within the three-dimensional space utilizing a pixel height for the pixel of the digital object from the object height map; determining a ground point corresponding to the pixel of the background within the three-dimensional space utilizing a pixel height for the pixel of the background from the background height map; and determining that the pixel of the digital object is blocking the light from reaching the pixel of the background utilizing the ground point corresponding to the pixel of the digital object and the ground point corresponding to the pixel of the background. Additionally, in some cases, determining that the pixel of the digital object is blocking the light from reaching the pixel of the background utilizing the ground point corresponding to the pixel of the digital object and the ground point corresponding to the pixel of the background comprises: determining a line between the ground point corresponding to the pixel of the background and a ground point corresponding to a light source of the digital image; and determining that the ground point corresponding to the pixel of the digital object is positioned on the line.

In one or more embodiments, modifying the digital image to include the object shadow for the digital object using the object height map and the background height map comprises generating a hard object shadow for the digital object using the object height map and the background height map. Further, in some embodiments, modifying the digital image to include the object shadow for the digital object comprises generating, utilizing a shadow stylization neural network, a soft object shadow for the digital object based on the hard object shadow.

To provide an illustration, in one or more embodiments, the height-based shadowing system 106 determines an object height map comprising pixel heights for pixels of a digital object portrayed in a digital image; determines a background height map comprising additional pixel heights for pixels of a background portrayed in the digital image; and modifies the digital image to include an object shadow for the digital object using the object height map and the background height map.

In some cases, the height-based shadowing system 106 further extracts, from the digital image, a background mask corresponding to the background portrayed in the digital image. Accordingly, in some embodiments, determining the background height map comprises generating, utilizing a height prediction neural network, the background height map based on the background mask. Further, in some embodiments, the height-based shadowing system 106 determines at least one of a background cutout for the background portrayed in the digital image or a coordinate scheme for the digital image. As such, in some instances, generating, utilizing the height prediction neural network, the background height map comprises generating, utilizing the height prediction neural network, the background height map based on the background cutout or the coordinate scheme.

In some instances, the height-based shadowing system 106 further determines a set of pixels from the pixels of the background that correspond to a shadow projection of the digital object within the digital image using the object height map and the background height map. Accordingly, in some embodiments, modifying the digital image to include the object shadow for the digital object using the object height map and the background height map comprises modifying the set of pixels from the pixels of the background to include shadow pixels based on determining that the set of pixels correspond to the shadow projection of the digital object.

In some cases, determining the set of pixels from the pixels of the background that correspond to the shadow projection of the digital object within the digital image, for a pixel of the background, comprises: determining a line between the pixel of the background and a light source of the digital image; identifying one or more pixels of the digital object that are positioned on the line; and determining whether at least one pixel from the one or more pixels of the digital object is blocking light from reaching the pixel of the background. In some implementations, determining whether the at least one pixel of the digital object is blocking the light from reaching the pixel of the background comprises: determining an additional line between a ground point for the pixel of the background and a ground point for the light source utilizing the background height map; determining a ground point for the at least one pixel of the digital object utilizing the object height map; and determining whether the ground point for the at least one pixel of the digital object is positioned on the additional line within a three-dimensional space corresponding to the digital image.

In one or more embodiments, determining whether the ground point for the at least one pixel of the digital object is positioned on the additional line comprises determining that the ground point for the at least one pixel of the digital object is positioned at a location other than the additional line. Accordingly, in some embodiments, the height-based shadowing system 106 maintains an initial value of the pixel of the background based on determining that the ground point for the at least one pixel of the digital object is positioned at the location other than the additional line. In some cases, determining whether the ground point for the at least one pixel of the digital object is positioned on the additional line comprises determining that the ground point for the at least one pixel of the digital object is positioned on the additional line. As such, in some instances, the height-based shadowing system 106 modifies the pixel of the background to include a shadow pixel based on determining that the ground point for the at least one pixel of the digital object is positioned on the additional line.

To provide another illustration, in one or more embodiments, the height-based shadowing system 106 receives a digital image portraying a digital object against a non-planar background; generates, utilizing a height prediction neural network, an object height map comprising pixel heights for pixels of a digital object; generates, utilizing the height prediction neural network, a background height map comprising additional pixel heights for pixels of the non-planar background; determines, utilizing the object height map and the background height map, ground points for the pixels of the digital object and the pixels of the non-planar background, a ground point for a pixel corresponding to a projection of the pixel onto a ground surface of the digital image; and generates, across the non-planar background within the digital image, an object shadow for the digital object utilizing the ground points. In some embodiments, generating, across the non-planar background within the digital image, the object shadow for the digital object utilizing the ground points comprises generating, utilizing the ground points, a hard object shadow for the digital object across the non-planar background.

In some instances, the height-based shadowing system 106 further determines a vertical movement of the digital object within the digital image; and adds a shift value to the pixel heights for the pixels of the digital object within the object height map in accordance with the vertical movement of the digital object. In some cases, the height-based shadowing system 106 further modifies the object shadow across the non-planar background within the digital image utilizing the background height map and the object height map with the shift value.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of an example computing device 900 that may be configured to perform one or more of the processes described above. One will appreciate that one or more computing devices, such as the computing device 900 may represent the computing devices described above (e.g., the server(s) 102 and/or the client devices 110a-110n). In one or more embodiments, the computing device 900 may be a mobile device (e.g., a mobile telephone, a smartphone, a PDA, a tablet, a laptop, a camera, a tracker, a watch, a wearable device). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 including storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of computing device 900 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
generating, utilizing a height prediction neural network, an object height map comprising pixel heights for pixels of a digital object portrayed in a digital image;
generating, utilizing the height prediction neural network, a background height map comprising additional pixel heights for pixels of a background portrayed in the digital image; and
modifying the digital image to include an object shadow for the digital object using the object height map and the background height map.

2. The method of claim 1,
further comprising determining a set of ground points corresponding to the pixels of the background utilizing the additional pixel heights for the pixels of the background from the background height map,
wherein modifying the digital image to include the object shadow for the digital object using the background height map comprises generating the object shadow for the digital object utilizing the set of ground points.

3. The method of claim 2,
further comprising determining an additional set of ground points corresponding to the pixels of the digital object utilizing the pixel heights for the pixels of the digital object from the object height map,
wherein modifying the digital image to include the object shadow for the digital object using the background height map comprises generating the object shadow for the digital object utilizing the additional set of ground points.

4. The method of claim 1,
further comprising determining that a pixel of the digital object is blocking light from reaching a pixel of the background within a three-dimensional space corresponding to the digital image utilizing the object height map and the background height map,
wherein modifying the digital image to include an object shadow for the digital object using the object height map and the background height map comprises modifying the pixel of the background to include a shadow pixel based on determining that the pixel of the digital object is blocking the light from reaching the pixel of the background.

5. The method of claim 4, wherein determining that the pixel of the digital object is blocking the light from reaching the pixel of the background within the three-dimensional space corresponding to the digital image utilizing the object height map and the background height map comprises:
determining a ground point corresponding to the pixel of the digital object within the three-dimensional space utilizing a pixel height for the pixel of the digital object from the object height map;
determining a ground point corresponding to the pixel of the background within the three-dimensional space utilizing a pixel height for the pixel of the background from the background height map; and
determining that the pixel of the digital object is blocking the light from reaching the pixel of the background utilizing the ground point corresponding to the pixel of the digital object and the ground point corresponding to the pixel of the background.

6. The method of claim 5, wherein determining that the pixel of the digital object is blocking the light from reaching the pixel of the background utilizing the ground point corresponding to the pixel of the digital object and the ground point corresponding to the pixel of the background comprises:
determining a line between the ground point corresponding to the pixel of the background and a ground point corresponding to a light source of the digital image; and
determining that the ground point corresponding to the pixel of the digital object is positioned on the line.

7. The method of claim 1, wherein modifying the digital image to include the object shadow for the digital object using the object height map and the background height map comprises generating a hard object shadow for the digital object using the object height map and the background height map.

8. The method of claim 7, wherein modifying the digital image to include the object shadow for the digital object comprises generating, utilizing a shadow stylization neural network, a soft object shadow for the digital object based on the hard object shadow.

9. A non-transitory computer-readable medium storing executable instructions, which when executed by a processing device, cause the processing device to perform operations comprising:
determining an object height map comprising pixel heights for pixels of a digital object portrayed in a digital image;
determining a background height map comprising additional pixel heights for pixels of a background portrayed in the digital image; and
modifying the digital image to include an object shadow for the digital object using the object height map and the background height map.

10. The non-transitory computer-readable medium of claim 9, wherein:
the operations further comprise extracting, from the digital image, a background mask corresponding to the background portrayed in the digital image; and
determining the background height map comprises generating, utilizing a height prediction neural network, the background height map based on the background mask.

11. The non-transitory computer-readable medium of claim 10, wherein:
the operations further comprise determining at least one of a background cutout for the background portrayed in the digital image or a coordinate scheme for the digital image; and
generating, utilizing the height prediction neural network, the background height map comprises generating, utilizing the height prediction neural network, the background height map based on the background cutout or the coordinate scheme.

12. The non-transitory computer-readable medium of claim 9, wherein:
the operations further comprise determining a set of pixels from the pixels of the background that correspond to a shadow projection of the digital object within the digital image using the object height map and the background height map; and
modifying the digital image to include the object shadow for the digital object using the object height map and the background height map comprises modifying the set of pixels from the pixels of the background to include shadow pixels based on determining that the set of pixels correspond to the shadow projection of the digital object.

13. The non-transitory computer-readable medium of claim 12, wherein determining the set of pixels from the pixels of the background that correspond to the shadow projection of the digital object within the digital image, for a pixel of the background, comprises:
determining a line between the pixel of the background and a light source of the digital image;
identifying one or more pixels of the digital object that are positioned on the line; and
determining whether at least one pixel from the one or more pixels of the digital object is blocking light from reaching the pixel of the background.

14. The non-transitory computer-readable medium of claim 13, wherein determining whether the at least one pixel of the digital object is blocking the light from reaching the pixel of the background comprises:
determining an additional line between a ground point for the pixel of the background and a ground point for the light source utilizing the background height map;
determining a ground point for the at least one pixel of the digital object utilizing the object height map; and
determining whether the ground point for the at least one pixel of the digital object is positioned on the additional line within a three-dimensional space corresponding to the digital image.

15. The non-transitory computer-readable medium of claim 14, wherein:
determining whether the ground point for the at least one pixel of the digital object is positioned on the additional line comprises determining that the ground point for the at least one pixel of the digital object is positioned at a location other than the additional line; and
the operations further comprise maintaining an initial value of the pixel of the background based on determining that the ground point for the at least one pixel of the digital object is positioned at the location other than the additional line.

16. The non-transitory computer-readable medium of claim 14, wherein:
determining whether the ground point for the at least one pixel of the digital object is positioned on the additional line comprises determining that the ground point for the at least one pixel of the digital object is positioned on the additional line; and
the operations further comprise modifying the pixel of the background to include a shadow pixel based on determining that the ground point for the at least one pixel of the digital object is positioned on the additional line.

17. A system comprising:
one or more memory components; and
one or more processing devices coupled to the one or more memory components, the one or more processing devices to perform operations comprising:
receiving a digital image portraying a digital object against a non-planar background;
generating, utilizing a height prediction neural network, an object height map comprising pixel heights for pixels of a digital object;
generating, utilizing the height prediction neural network, a background height map comprising additional pixel heights for pixels of the non-planar background;
determining, utilizing the object height map and the background height map, ground points for the pixels of the digital object and the pixels of the non-planar background, a ground point for a pixel corresponding to a projection of the pixel onto a ground surface of the digital image; and
generating, across the non-planar background within the digital image, an object shadow for the digital object utilizing the ground points.

18. The system of claim 17, wherein the one or more processing devices further perform operations comprising:
determining a vertical movement of the digital object within the digital image; and
adding a shift value to the pixel heights for the pixels of the digital object within the object height map in accordance with the vertical movement of the digital object.

19. The system of claim 18, wherein the one or more processing devices further perform operations comprising modifying the object shadow across the non-planar background within the digital image utilizing the background height map and the object height map with the shift value.

20. The system of claim 17, wherein generating, across the non-planar background within the digital image, the object shadow for the digital object utilizing the ground points comprises generating, utilizing the ground points, a hard object shadow for the digital object across the non-planar background.
